(19) United States
(12) Patent Application Publication
(10) Pub. No.: US 2021/0146955 A1
(43) Pub. Date: May 20, 2021

(54) VEHICLE CONTROL SYSTEM, VEHICLE CONTROL METHOD, AND PROGRAM

(71) Applicant: HONDA MOTOR CO., LTD., Minato-ku, Tokyo (JP)

(72) Inventors: Yuji Yasui, Wako-shi (JP); Kentaro Ishisaka, Wako-shi (JP); Nobuyuki Watanabe, Wako-shi (JP); Kovi Ahego, Wako-shi (JP); Christopher Lang, Wako-shi (JP); Liyan Liu, Tokyo (JP); Yo Ito, Tokyo (JP); Hirotaka Uchitomi, Tokyo (JP)

(21) Appl. No.: 16/621,997

(22) PCT Filed: Jun. 12, 2018
(86) PCT No.: PCT/JP2018/022319

§ 371 Date: Dec. 12, 2019

(30) Foreign Application Priority Data
Jun. 16, 2017 (JP) 2017-118696

(51) Int. Cl. B60W 60/00; B60W 50/00; B60W 40/08; G01C 21/34

(52) U.S. Cl. CPC B60W 60/0013; B60W 50/0097; B60W 40/08; G01C 21/3461; B60W 2554/4042; B60W 2554/4029; B60W 2420/42; B60W 2420/52; B60W 2554/4041; B60W 2540/22

(57) ABSTRACT

A vehicle control system includes: a detector configured to detect objects around a vehicle; a predictor configured to predict the extent of stress caused to an occupant by the objects according to a distribution of the objects detected by the detector; and a controller configured to generate a trajectory when the vehicle is traveling by automated driving according to the extent of stress predicted by the predictor.

### TECHNICAL FIELD

Aspects of the present invention relate to a vehicle control system, a vehicle control method, and a program.

Priority is claimed on Japanese Patent Application No. 2017-118696, filed Jun. 16, 2017, the content of which is incorporated herein by reference.

### BACKGROUND ART

In the related art, a device that determines a driving action taken in a road situation in accordance with a time element including a time point at which a vehicle is expected to arrive at a limitation range and presents the driving action determined before the vehicle arrives at the limitation range according to registered content of a limitation range database in which the limitation range in a road situation in which a traveling state of a vehicle has to be limited in accordance with time elements such as a day of week, a season, and a period of time is registered in association with map data is known (for example, see Patent Document 1).

### CITATION LIST

### Patent Literature

### [Patent Document 1]

Japanese Unexamined Patent Application, First Publication No. 2015-42946

### SUMMARY OF INVENTION

### Technical Problem

In the foregoing device, however, stress caused to an occupant due to objects around vehicles has not been taken into consideration.

The present invention is devised in consideration of such circumstances and an objective of the present invention is to suppress stress being caused to an occupant.

### Solution to Problem

A vehicle control system, a vehicle control method, and a program according to the present invention adopt the following configurations.

(1) According to an aspect of the present invention, a vehicle control system includes: a detector configured to detect objects around a vehicle; a predictor configured to predict the extent of stress caused to an occupant by the objects according to a distribution of the objects detected by the detector; and a controller configured to generate a trajectory when the vehicle is traveling by automated driving according to the extent of stress predicted by the predictor.

(2) In the vehicle control system according to the foregoing aspect (1), the controller may generate a trajectory when the vehicle is traveling automatically according to the extent of stress predicted by the predictor and the distribution of the objects detected by the detector.

(3) In the vehicle control system according to the foregoing aspect (2), the trajectory may be a trajectory in which the extent of stress on the occupant is equal to or less than a first threshold.

(4) In the vehicle control system according to the foregoing aspect (3), the trajectory in which the extent of stress on the occupant is equal to or less than the first threshold may be a trajectory passing through a position further away from the objects than a trajectory in which the extent of stress on the occupant is greater than the first threshold.

(5) In the vehicle control system according to the foregoing aspect (5), the trajectory in which the extent of stress on the occupant is equal to or less than the first threshold may be a trajectory in which a vehicle speed or acceleration is suppressed further than the trajectory in which the extent of stress on the occupant is greater than the first threshold.

(6) The vehicle control system according to the foregoing aspect (1) may further include an occupant monitor configured to estimate the extent of stress on the occupant. When the vehicle is traveling along the generated trajectory a predetermined time before and the extent of stress estimated by the occupant monitor is equal to or greater than a second threshold, the controller is configured to generate a trajectory for the vehicle to travel by the automated driving according to the extent of stress estimated by the occupant monitor and equal to or greater than the second threshold.

(7) In the vehicle control system according to the foregoing aspect (1), with reference to information regarding a specific route in which it is predicted that the extent of stress when the vehicle is traveling is equal to or greater than a third threshold, the controller may determine that the vehicle is traveling preferentially along a route different the specific route.

(8) According to another aspect of the present invention, a vehicle control method causes an in-vehicle computer to: detect objects around a vehicle; predict the extent of stress caused to an occupant by the objects according to a distribution of the detected objects; and generate a trajectory when the vehicle is traveling by automated driving according to the predicted extent of stress.

(9) According to still another aspect of the present invention, a program causes an in-vehicle computer to: detect objects around a vehicle; predict the extent of stress caused to an occupant by the objects according to a distribution of the detected objects; and generate a trajectory when the vehicle is traveling by automated driving according to the predicted extent of stress.

### Advantageous Effects of Invention

According to the foregoing aspects (1) to (9), by generating a trajectory when a vehicle is traveling by automated driving according to the extent of stress caused to an occupant, it is possible to suppress the stress being caused to the occupant.

### BRIEF DESCRIPTION OF DRAWINGS

FIG. 1 is a diagram showing a configuration of a vehicle control system 1 mounted in a vehicle.

FIG. 2 is a diagram showing a state in which a relative position and posture of a vehicle with respect to a traveling lane L1 are recognized by an own vehicle position recognizer 122.

FIG. 3 is a diagram showing a process procedure of automated driving.

FIG. 4 is a diagram showing an example of stress suppression information 152.

FIG. 5 is a diagram showing an example of pattern information 154.

FIG. 6 is a diagram showing an example of section information 156.

FIG. 7 is a flowchart (part 1) showing a flow of a process performed by the vehicle control system 1.

FIG. 8 is a flowchart (part 2) showing the flow of the process performed by the vehicle control system 1.

FIG. 9A is a diagram showing an example of a behavior of a vehicle Mx when a trajectory is not corrected.

FIG. 9B is a diagram showing an example of a behavior of a vehicle M when a trajectory is corrected.

FIG. 10 is a diagram showing examples of transitions of speeds of the vehicles Mx and M in scenarios of FIG. 9.

FIG. 11 is a diagram showing examples of transitions of the extent of stress on an occupant in the scenarios of FIGS. 9 and 10.

FIG. 12 is a diagram showing a functional configuration of an analysis device 400.

FIG. 13 is a diagram showing an example of an image captured by a camera of a vehicle.

FIG. 14 is a diagram showing an example of information regarding stress transmitted from a biological sensor to a vehicle.

FIG. 15 is a flowchart showing a flow of a process performed by the analysis device 400.

FIG. 16 is a diagram showing an example of a bird's eye view image.

### DESCRIPTION OF EMBODIMENTS

Hereinafter, embodiments of a vehicle control system, a vehicle control method, and a program according to the present invention will be described with reference to the drawings.

### [Overall Configuration]

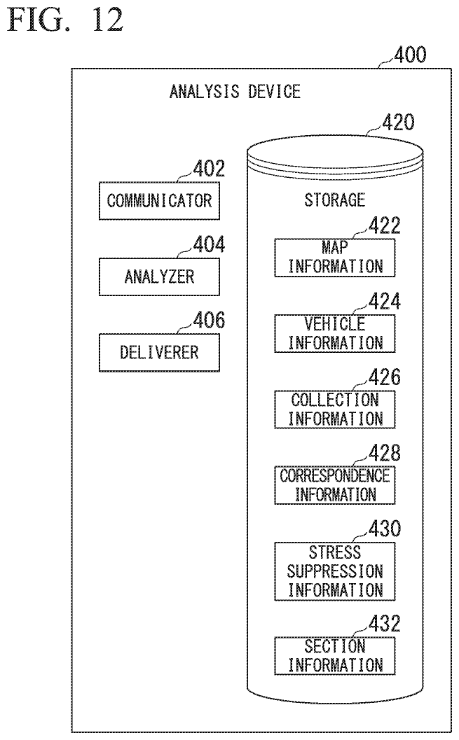

The vehicle system includes, for example, one or more vehicles and an analysis device 400 (see FIG. 12). The vehicles and the analysis device 400 communicate with one another via a network. The network includes, for example, a cellular network, a Wi-Fi network, a wide area network (WAN), a local area network (LAN), and a wireless base station.

The analysis device 400 analyzes predetermined information and generates stress suppression information to be described below according to an analysis result. The vehicle controls the own using the stress suppression information acquired from the analysis device 400.

### [Vehicle]

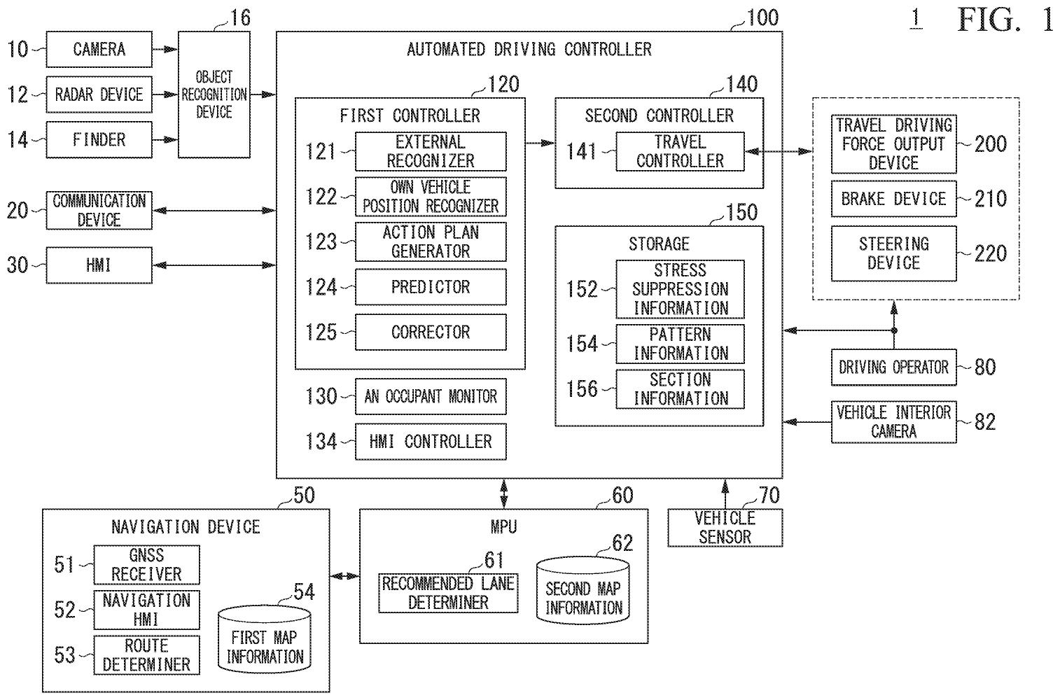

FIG. 1 is a diagram showing a configuration of a vehicle control system 1 mounted in a vehicle. A vehicle in which the vehicle control system 1 is mounted is, for example, a vehicle such as a two-wheeled vehicle, a three-wheeled vehicle, or a four-wheeled vehicle. A driving source of the vehicle includes an internal combustion engine such as a diesel engine or a gasoline engine, an electric motor, and a combination thereof. The electric motor operates using power generated by a power generator connected to the internal combustion engine or power discharged from a secondary cell or a fuel cell.

The vehicle control system 1 includes, for example, a camera 10, a radar device 12, a finder 14, an object recognition device 16, a communication device 20, a human machine interface (HMI) 30, a navigation device 50, a map positioning unit (MPU) 60, a vehicle sensor 70, a driving operator 80, a vehicle interior camera 82, an automated driving controller 100, a travel driving force output device 200, a brake device 210, and a steering device 220. The devices and units are connected to one another via a multiplex communication line such as a controller area network (CAN) communication line, a serial communication line, or a wireless communication network. The configuration shown in FIG. 1 is merely exemplary, a part of the configuration may be omitted, and another configuration may be further added.

The camera 10 is, for example, a digital camera that uses a solid-state image sensor such as a charged coupled device (CCD) or a complementary metal oxide semiconductor (CMOS). The plurality of cameras 10 are mounted on any portions of a vehicle in which the vehicle control system 1 is mounted. For example, the cameras 10 image a front side and are mounted on an upper portion of a front windshield, a rear surface of a rearview mirror, and the like. The cameras 10 may be stereo cameras.

The radar device 12 radiates radio waves such as millimeter waves to the surroundings of the vehicle and detects radio waves (reflected waves) reflected from an object to detect at least a position of the object (a distance to and an azimuth of the object). The single radar device 12 is mounted on one portion or a plurality of portions of the vehicle. The radar device 12 may detect a position and a speed of an object in conformity with a frequency modulated continuous wave (FM-CW) scheme.

The finder 14 is a light detection and ranging or laser imaging detection and ranging (LIDAR) finder and measures scattered light of radiated light and detects a distance to a target. One finder 14 or the plurality of finders 14 are mounted on any portions of the vehicle.

The object recognition device 16 performs a sensor fusion process on detection results from some or all of the camera 10, the radar device 12, and the finder 14 and recognizes a position, a type, a speed, and the like of an object. The object recognition device 16 outputs a recognition result to the automated driving controller 100.

The communication device 20 communicates with other vehicles around the vehicle using, for example, a cellular network, a Wi-Fi network, Bluetooth (registered trademark), dedicated short range communication (DSRC) or the like or communicates with various server devices via wireless base stations.

The HMI 30 presents various types of information to occupants of the vehicle and receives input operations by the occupants. For example, the HMI 30 includes various display devices, speakers, buzzers, touch panels, switches, and keys.

The navigation device 50 includes, for example, a global navigation satellite system (GNSS) receiver 51, a navigation HMI 52, and a route determiner 53 and retains first map information 54 in a storage device such as a hard disk drive (HDD) or a flash memory. The GNSS receiver specifies a position of the vehicle according to signals received from GNSS satellites. The position of the vehicle may be specified or complemented by an inertial navigation system (INS) using an output of the vehicle sensor 70. The navigation HMI 52 includes a display device, a speaker, a touch panel, and a key. The navigation HMI 52 may be partially or entirely common to the above-described HMI 30. The route determiner 53 determines, for example, a route from a position of the vehicle specified by the GNSS receiver 51 (or any input position) to a destination input by an occupant using the navigation HMI 52 with reference to the first map information 54. The first map information 54 is, for example, information in which a road shape is expressed by links indicating roads and nodes connected by the links. The first map information 54 may include curvatures of roads and point of interest (POI) information. The route determined by the route determiner 53 is output to the MPU 60. The navigation device 50 may perform route guidance using the navigation HMI 52 according to the route determined by the route determiner 53. The navigation device 50 may be realized by, for example, a function of a terminal device such as a smartphone or a tablet terminal possessed by a user. The navigation device 50 may transmit a current position and a destination to a navigation server via the communication device 20 to acquire the route responded from the navigation server.

The MPU 60 functions as, for example, a recommended lane determiner 61 and retains second map information 62 in a storage device such as an HDD or a flash memory. The recommended lane determiner 61 divides the route provided from the navigation device 50 into a plurality of blocks (for example, divides the route in a vehicle movement direction for each 100 [m]) and determines a recommended lane for each block with reference to the second map information 62. The recommended lane determiner 61 determines in which lane the vehicle travels from the left. When there is a branching location or a joining location in the route, the recommended lane determiner 61 determines a recommended lane so that the own vehicle can travel in a reasonable traveling route to move to a branching destination.

The second map information 62 is map information that has higher precision than the first map information 54. The second map information 62 includes, for example, information regarding the middles of lanes or information regarding boundaries of lanes. The second map information 62 may include road information, traffic regulation information, address information (address and postal number), facility information, and telephone number information. The road information includes information indicating kinds of roads such as expressways, toll roads, national ways, or prefecture roads and information such as the number of lanes of roads, the width of each lane, the gradients of roads, the positions of roads (3-dimensional coordinates including longitude, latitude, and height), curvatures of curves of lanes, positions of joining and branching spots of lanes, and signs installed on roads. The second map information 62 may be updated frequently by accessing another device using the communication device 20.

In the second map information 62, information indicating a gate structure of an entrance tollgate, an exit tollgate, and the like is stored. The information indicating the gate structure is, for example, information indicating the number of gates provided in a tollgate or the positions of the gates.

The vehicle sensor 70 includes a vehicle speed sensor that detects a speed of the vehicle, an acceleration sensor that detects acceleration, a yaw rate sensor that detects an angular velocity around a vertical axis, and an azimuth sensor that detects a direction of the vehicle.

The driving operator 80 includes, for example, an accelerator pedal, a brake pedal, a shift lever, a steering wheel, and other operators. A sensor that detects whether there is an operation or an operation amount is mounted in the driving operator 80 and a detection result is output to the automated driving controller 100 or the travel driving force output device 200 and one or both of the brake device 210 and the steering device 220.

The vehicle interior camera 82 images the upper half body of an occupant sitting on a driving seat centering on his or her face. A captured image of the vehicle interior camera 82 is output to the automated driving controller 100.

The automated driving controller 100 includes, for example, a first controller 120, a second controller 140, and a storage 150. One or both of the first controller 120 and the second controller 140 is realized, for example, by causing a processor such as a central processing unit (CPU) to execute a program (software). Some or all of the function units may be realized by hardware such as a large scale integration (LSI), an application specific integrated circuit (ASIC), a field-programmable gate array (FPGA), or a graphics processing unit (GPU), or may be realized by software and hardware in cooperation. The program may be stored in advance in a storage device such as a hard disk drive (HDD) or a flash memory or may be stored in a storage medium detachably mounted on a DVD, a CD-ROM, or the like so that the storage medium is mounted on a drive device and is installed on the storage device. The storage 150 is realized by, for example, a nonvolatile storage device such as a read-only memory (ROM), an electrically erasable and programmable read-only memory (EEPROM), or a hard disk drive (HDD) and a volatile storage device such as a random access memory (RAM) or a register.

The first controller 120 includes, for example, an external recognizer (a detector) 121, an own vehicle position recognizer 122, an action plan generator 123, a predictor 124, and a corrector 125.

The external recognizer 121 recognizes states of nearby vehicles, such as positions, speeds, acceleration, or the like, according to information input from the camera 10, the radar device 12, and the finder 14 via the object recognition device 16. The positions of the nearby vehicles may be represented as representative points such as centers of gravity, corners, or the like of the nearby vehicles or may be represented as regions expressed by contours of the nearby vehicles. The “states” of the nearby vehicles may include acceleration or jerk of the nearby vehicles or “action states” (for example, the nearby vehicles are changing their lanes or whether the nearby vehicles are changing their lanes or are attempting to change their lanes). The external recognizer 121 may recognize the positions of other objects such as guide rails, electric poles, parked vehicles, and pedestrians in addition to the nearby vehicles.

The own vehicle position recognizer 122 recognizes, for example, a lane along which the vehicle is traveling (a traveling lane) and a relative position and posture of the vehicle with respect to the traveling lane. The own vehicle position recognizer 122 recognizes, for example, the traveling lane by comparing patterns of road mark lines (for example, arrangement of continuous lines and broken lines) obtained from the second map information 62 with patterns of road mark lines around the vehicle recognized from images captured by the camera 10. In this recognition, the position of the vehicle acquired from navigation device 50 or a process result by INS may be taken into account.

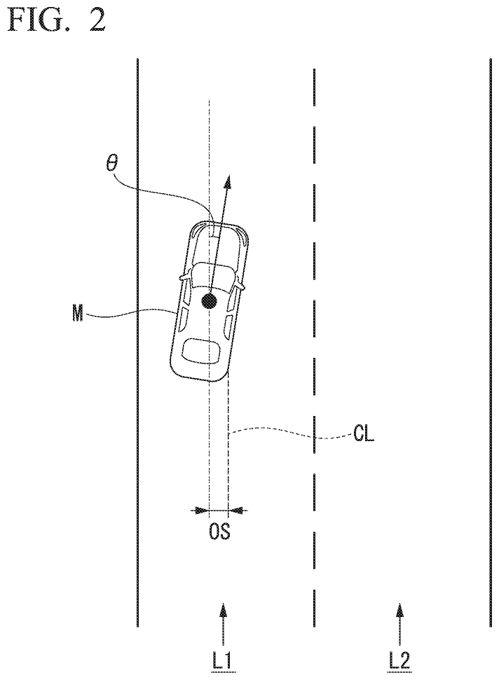

Then, the own vehicle position recognizer 122 recognizes, for example, a position or an attitude of the vehicle with respect to a traveling lane. FIG. 2 is a diagram showing an aspect in which a relative position and posture of the vehicle with respect to a traveling lane L1 are recognized by the own vehicle position recognizer 122. The own vehicle position recognizer 122 recognizes, for example, a deviation OS from a traveling lane center CL of a reference point (for example, a center of gravity) of the vehicle M and an angle θ formed with respect to a line drawn with the traveling lane center CL in the movement direction of the vehicle M as the relative position and posture of the vehicle M with respect to the traveling lane L1. Instead of this, the own vehicle position recognizer 122 may recognize a position or the like of the reference point of the vehicle M with respect to a right road mark line (or a left road mark line) of the own lane L1 as the relative position of the vehicle M with respect to the traveling lane. The relative position of the vehicle M recognized by the own vehicle position recognizer 122 is supplied to the recommended lane determiner 61 and the action plan generator 123.

The action plan generator 123 determines events which are sequentially performed in automated driving so that the vehicle travels along the recommended lane determined by the recommended lane determiner 61 and nearby situations of the vehicle M can be handled. As the events, for example, there are a constant speed traveling event for traveling at a constant speed along the same traveling lane, a following travel event for traveling and following a preceding vehicle (an event along which the own vehicle is traveling maintaining an inter-vehicle distance to a preceding vehicle by a set distance), a lane changing event, a joining event, a branching event, an emergency stop event, a handover event for ending automated driving to switch the automated driving to non-automated driving, a tollgate event (to be described below) at the time of passage through a tollgate, and the like. While such an event is being performed, an action for avoidance is planned according to a nearby situation (presence of a nearby vehicle or a pedestrian, lane constriction due to road construction, or the like) of the vehicle M in some cases.

The action plan generator 123 generates a target trajectory along which the vehicle M travels in future. The target trajectory includes, for example, a speed component. For example, the target trajectory is generated as a set of target spots (trajectory points) at which a vehicle arrives at a plurality of future reference times set for each predetermined sampling time (for example, about tenths of a second). Therefore, when an interval between trajectory points is large, it is assumed that the vehicle is traveling a section between the trajectory points at a high speed.

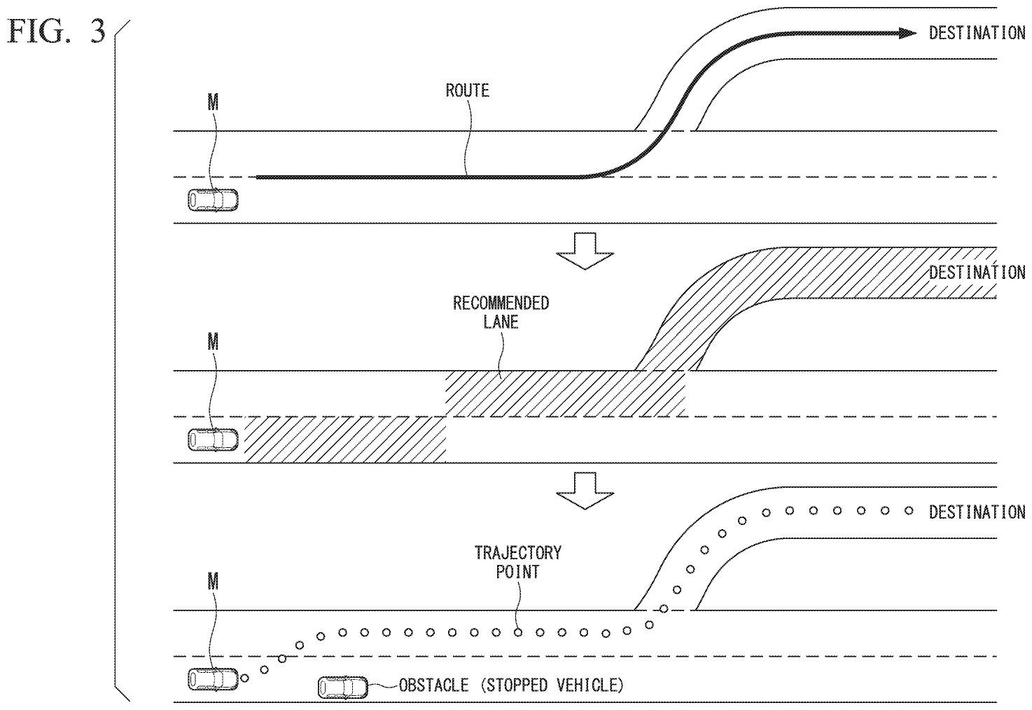

FIG. 3 is a diagram showing a process procedure of automated driving. First, as shown in the upper drawing, the navigation device 50 determines a route. This route is, for example, a rough route in which lanes are not distinguished. Subsequently, as shown in the middle drawing, the recommended lane determination device 240 determines a recommended lane in which the vehicle easily travels along a route. As shown in the lower drawing, the automated driving controller 250 generates trajectory points for traveling along the recommended lane if possible, for example, while avoiding obstacles and controls some or all of the travel driving force output device 200, the brake device 210, and the steering device 220 such that the vehicle travels along the trajectory points (and a subordinate speed profile). The role sharing is merely exemplary and, for example, the automated driving controller 100 may perform processes unitarily.

For example, the action plan generator 123 generates a plurality of candidates for the target trajectory and selects an optimum target trajectory at that time according to the perspective of safety and efficiency.

The predictor 124 predicts the extent of stress caused to an occupant by the objects according to a distribution of objects recognized by the external recognizer 121. The details will be described below.

The corrector 125 corrects an action plane generated by the action plan generator 123 according to stress suppression information 152 (to be described below) stored in the storage 150 and generates a trajectory in which stress on an occupant is suppressed.

An occupant monitor 130 analyzes an expression of an occupant according to an image captured by the vehicle interior camera 82 and estimates the extent of stress on the occupant according to an analysis result. For example, an analysis result of an image in which an expression of an occupant is imaged when the occupant feels stress is stored in the storage 150. The analysis result is stored in the storage 150, for example, for each extent of stress. The occupant monitor 130 compares an analysis result stored in the storage 150 with the analysis result of the image captured by the vehicle interior camera 82 and estimates the extent of stress on the occupant. The occupant monitor 130 may acquire a detection result of the extent of stress acquired by a biological sensor fixed to the body of the occupant through wireless communication or the like and may estimate the extent of stress on the occupant according to the acquired detection result of the biological sensor. The occupant monitor 130 may integrate the detection result of the biological sensor and the analysis result of the image captured by the vehicle interior camera 82 and may estimate the extent of stress on the occupant.

The HMI controller 134 controls the HMI 30.

The second controller 140 includes a travel controller 141. The travel controller 141 controls the travel driving force output device 200, the brake device 210, and the steering device 220 such that the vehicle M passes through a target trajectory generated by the action plan generator 123 at a scheduled time.

The storage 150 stores, for example, the stress suppression information 152, pattern information 154, and section information 156. The stress suppression information 152, the pattern information 154, and the section information 156 are, for example, information delivered by the analysis device 400.

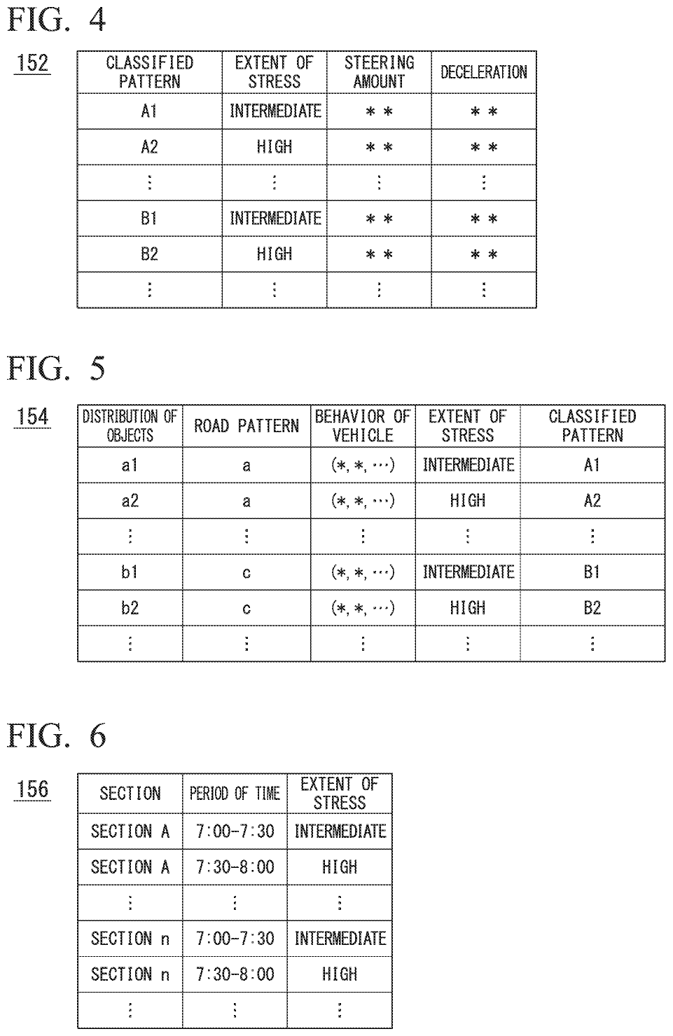

The stress suppression information 152 is information used when the vehicle M travels so that stress on an occupant is suppressed. FIG. 4 is a diagram showing an example of the stress suppression information 152. The stress suppression information 152 is information in which classified patterns, the extent of stress, and correction values are associated with one another. The classified patterns are determined in accordance with the pattern information 154 to be described below. The correction values are correction values (for example, a steering amount, deceleration, and the like) of behaviors when the vehicle travels along the trajectory generated by the action plan generator 123 under the same conditions.

FIG. 5 is a diagram showing an example of pattern information 154. The pattern information 154 is information for specifying the extent of stress which an occupant is predicted to feel or a classified pattern according to a distribution of objects, a road pattern, and a behavior of the vehicle M. The distribution of the objects, the road pattern, the behavior of the vehicle M, the extent of stress, and the classified pattern are associated with the pattern information 154. The distribution of the objects is a distribution of objects in a bird's eye view image when the image is viewed from the vertically upper side. For example, an image is converted into a bird's eye view image by the external recognizer 121 (see FIG. 16). The road pattern is a pattern in which aspects of roads are classified according to a predetermined reference. The predetermined reference is, for example, the number of lanes of a road, the width of a road, characteristics of a road (streets in front of stations or streets of residential areas), aspects of pavements, and the like. The road patterns may be associated with nodes or links in map information. The classified patterns are patterns in which a distribution of objects, road patterns, and behaviors of a vehicle are classified according to a predetermined reference.

The section information 156 is information in which a combination of a section in which the extent of stress on an occupant is equal to or greater than a threshold (a first threshold or a third threshold) and a period of time can be recognized. FIG. 6 is a diagram showing an example of the section information 156.

The travel driving force output device 200 outputs a travel driving force (torque) for traveling the vehicle M to a driving wheel. The travel driving force output device 200 includes, for example, a combination of an internal combustion engine, an electric motor and a transmission, and an electronic control unit (ECU) controlling these units. The ECU controls the foregoing configuration in accordance with information input from the travel controller 141 or information input from the driving operator 80.

The brake device 210 includes, for example, a brake caliper, a cylinder that transmits a hydraulic pressure to the brake caliper, an electronic motor that generates a hydraulic pressure in the cylinder, and a brake ECU. The brake ECU controls the electric motor in accordance with information input from the travel controller 141 or information input from the driving operator 80 such that a brake torque in accordance with a brake operation is output to each wheel. The brake device 210 may include a mechanism that transmits a hydraulic pressure generated in response to an operation of the brake pedal included in the driving operator 80 to the cylinder via a master cylinder as a backup. The brake device 210 is not limited to the above-described configuration and may be an electronic control type hydraulic brake device that controls an actuator in accordance with information input from the travel controller 141 such that a hydraulic pressure of the master cylinder is transmitted to the cylinder.

The steering device 220 includes, for example, a steering ECU and an electric motor. The electric motor applies a force to, for example, a rack and pinion mechanism to change a direction of a steering wheel. The steering ECU drives the electric motor to change the direction of the steering wheel in accordance with information input from the travel controller 141 or information input from the driving operator 80.

### [Process of Vehicle M]

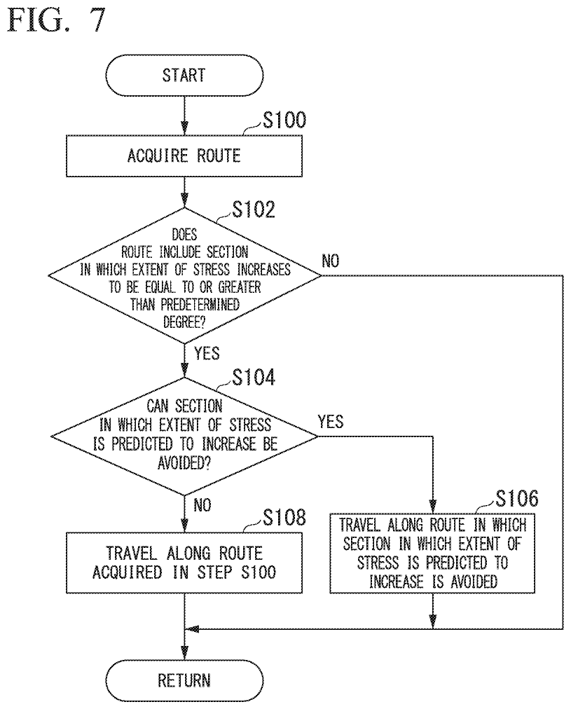

FIG. 7 is a flowchart (part 1) showing a flow of a process performed by the vehicle control system 1. First, the automated driving controller 100 acquires a route of the vehicle M from the navigation device 50 (step S100). Subsequently, the predictor 124 determines whether the route acquired in step S100 includes a section in which the extent of stress is predicted to increase to be equal to or greater than a predetermined extent at a time at which the vehicle M is scheduled to travel with reference to the section information 160 (step S102). When the acquired route does not include the section in which the extent of stress is predicted to increase to be equal or to greater than the predetermined extent, the process of one route of the flowchart ends.

When the acquired route includes a section in which the extent of stress is predicted to increase to be equal to or greater than the predetermined extent, the predictor 124 determines whether the section in which the extent of stress is predicted to increase can be avoided (step S104). For example, the determination is performed as follows. The predictor 124 instructs the navigation device 50 to generate another route. When the navigation device 50 acquires the instruction, the navigation device 50 generates the other route and transmits the generated route to the predictor 124. For example, when the newly generated route is a an inefficient route (a route in which a time taken to arrive at a destination is a predetermined time or more or a route for bypassing a predetermined distance or more), the predictor 124 determines that the section in which the extent of stress is predicted to increase by the predetermined extent or more cannot be avoided. When it is determined that the newly generated route is not the inefficient route, the predictor 124 determines that the section in which the extent of stress is predicted to increase to be equal to or greater than the predetermined extent can be avoided.

When the section in which the extent of stress is predicted to increase to be equal to or greater than the predetermined extent can be avoided, the automated driving controller 100 controls the vehicle M such that the vehicle M travels along the route in which the section in which the extent of stress is predicted to increase to be equal to or greater than the predetermined extent can be avoided (step S106). That is, the automated driving controller 100 controls the vehicle M such that the vehicle M preferentially travels in a section (route) different from the section (specific route) in which the extent of stress is predicted to increase to be equal to or greater than the predetermined extent. The route in which the section in which the extent of stress is predicted to increase to be equal to or greater than the predetermined extent is avoided is, for example, the most efficient route among the newly generated routes determined not to be inefficient.

When the section in which the extent of stress is predicted to increase to be equal to or greater than the predetermined extent cannot be avoided, the automated driving controller 100 controls the vehicle M such that the vehicle M travels along the route acquired in step S100 (step S108). In this case, the HMI controller 134 may output information for controlling the HMI 30 and comforting an occupant to the HMI 30. For example, the HMI controller 134 causes a voice “Relax. Vehicle is traveling without high stress.” to be output to the HMI 30. The HMI controller 134 may output the voice to the HMI 30 when the occupant monitor 130 estimates that stress on the occupant is equal to or greater than the predetermined extent. Thus, the process of one route of the flowchart ends.

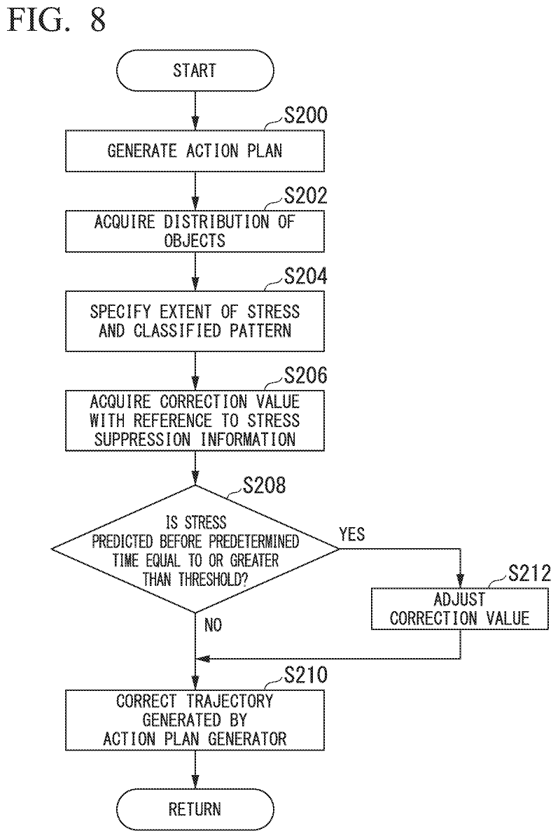

Through the above-described process, the vehicle control system 1 can avoid the section in which the extent of stress on the occupant is predicted to increase. When the section in which the extent of stress on the occupant predicted to increase cannot be avoided, the process of the flowchart of FIG. 8 is performed.

FIG. 8 is a flowchart (part 2) showing the flow of the process performed by the vehicle control system 1. First, the action plan generator 123 generates an action plan (step S200). Subsequently, the predictor 124 acquires the distribution of the objects from the external recognizer 121 (step 202). Subsequently, the predictor 124 specifies the extent of stress predicted to be felt by the occupant and a classified pattern according to the distribution of the objects, the road pattern, and the behavior of the vehicle M with reference to the pattern information 154 (step S204).

Subsequently, the corrector 125 acquires a correction value according to the extent of stress predicted to be the classified pattern specified in step S204 with reference to the stress suppression information 152 (step S206). Subsequently, the corrector 125 determines whether the extent of stress estimated by the occupant monitor 130 a predetermined time before is equal to or greater than a threshold (a second threshold) (step S208). A timing the predetermined time before is a timing at which a process of correcting a trajectory is performed previously according to the stress suppression information 152 and the vehicle M travels along the trajectory.

When the extent of stress estimated by the occupant monitor 130 the predetermined time before is not equal to or greater than the threshold, the corrector 125 corrects the trajectory generated by the action plan generator 123 using the correction value acquired in step S206 (step S210). When the extent of stress specified in step S204 is equal to or less than a predetermined value, the trajectory may not be corrected.

When the extent of stress estimated by the occupant monitor 130 is equal to or greater than the threshold the predetermined time before, the corrector 125 adjusts the correction value in accordance with the estimated extent of stress (step S212) and the process moves to step S210. The correction value is adjusted with reference to, for example, an adjustment map (not shown) stored in the storage 150. The adjustment map is generated such that the correction value associated with the extent of stress is larger as the magnitude of the extent of stress equal to or greater than the threshold is larger. That is, the adjustment map is a map in which the correction value is adjusted such that the extent of stress on the occupant is less than a threshold (the first threshold or the second threshold). In this way, the correction value is adjusted in accordance with a stress feeling of the occupant by adjusting the correction value in accordance with the adjustment map, and a trajectory along which the vehicle M travels is generated so that the extent of stress on the occupant is less than the threshold. Thus, the process of one routine of the flowchart ends.

As described above, the corrector 125 can suppress stress caused to the occupant by correcting the trajectory.

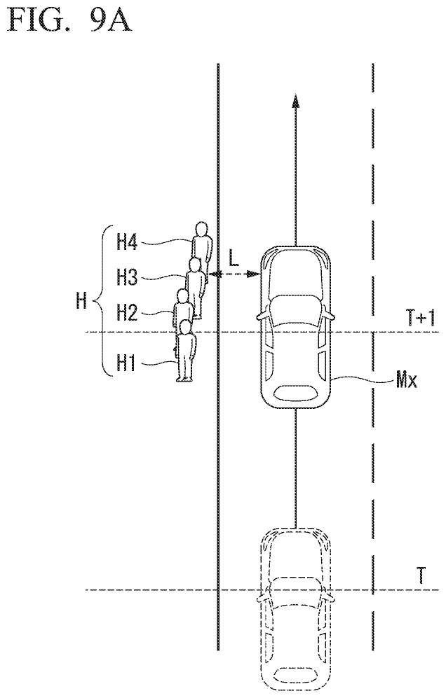

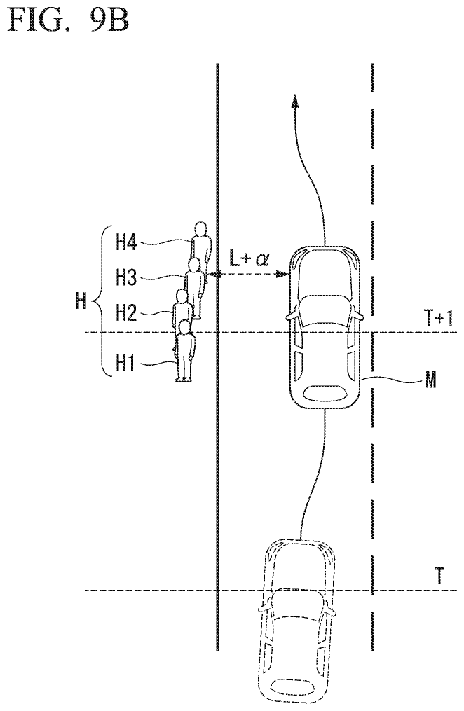

FIG. 9 is a diagram showing an example of a behavior of a vehicle Mx when a trajectory is not corrected and an example of a behavior of a vehicle M when a trajectory is corrected. In the shown examples, humans H (H1 to H4) are on the sides of a traveling lane. FIG. 9A shows a behavior of the vehicle Mx when a trajectory is not corrected. FIG. 9B shows a behavior of the vehicle M when a trajectory is corrected. For example, in FIG. 9A, the vehicle Mx is traveling near the center of a traveling lane at time T and time T+1. In this case, when the vehicle M passes through a region in which there are humans, an occupant of the vehicle Mx may feel stress due to a short distance L between the vehicle Mx and humans H. On the other hand, in FIG. 9B, the vehicle M travels away from humans in a lateral direction from the vicinity of the center of a traveling lane within the traveling lane, and ensures a distance L+α (>the distance L) at time T and passes through a region in which there are humans. Thereafter, the vehicle M travels along the center of the traveling lane. In this way, the vehicle M travels so that stress on the occupant is suppressed.

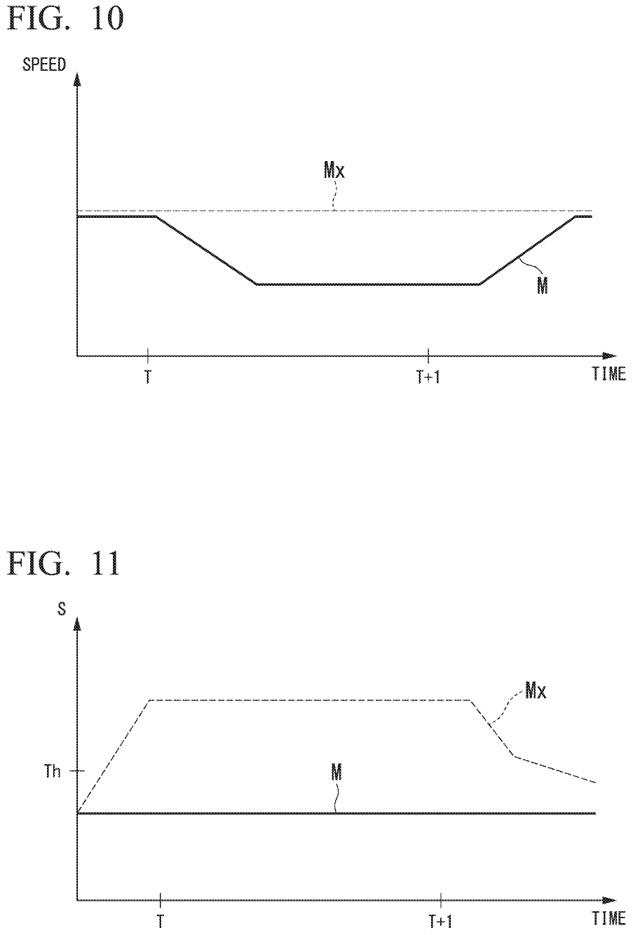

In FIG. 9, the traveling position of the vehicle M with respect to the humans has been described, but a speed (or acceleration) of the vehicle M may also be corrected, as shown in FIG. 10. FIG. 10 is a diagram showing examples of transitions of speeds of the vehicles Mx and M in scenarios of FIG. 9. In FIG. 10, the vertical axis represents a speed of a vehicle and the horizontal axis represents a time. A solid line indicates a transition of a speed of the vehicle M and a dotted line indicates a transition of a speed of the vehicle Mx. The speed of the vehicle Mx is constant. On the other hand, the vehicle M gradually decelerates up to predetermined speed from time T and passes through the region in which there are the humans H at a predetermined speed. Then, the vehicle M accelerates up to the speed before the time T and travels after a predetermined time passes from time T+1. In this way, through the correction of the corrector 125, the vehicle M decelerates when the vehicle M passes through the region in which there are the humans H. Therefore, the stress felt by the occupant is suppressed.

FIG. 11 is a diagram showing examples of transitions of the extent of stress on an occupant in the scenarios of FIGS. 9 and 10. In FIG. 11, the vertical axis represents the extent of stress on the occupant in the vehicle M and the horizontal axis indicates a time. A solid line indicates a transition of the extent of stress on the occupant in the vehicle M and a dotted line indicates a transition of the extent of stress on the occupant in the vehicle Mx. The extent of stress on the occupant in the vehicle Mx is higher in some cases than the extent of stress on the occupant when the vehicle Mx travels through a region in which there are no humans between time T and time T+1 (between before and after the vehicle passes through the region in which there are humans). On the other hand, the extent of stress on the occupant in the vehicle M is constant and equal to or less than a threshold (first threshold) Th. That is, the extent of stress when the vehicle travels through the region in which there are humans is equal to the extent of stress when the vehicle travels through the region in which there are no humans. In this way, the corrector 125 corrects the trajectory, thereby suppressing the stress on the occupant.

The stress suppression information 152 may be generated according to a detection frequency of objects for a predetermined time (or a predetermined traveling distance), a passage frequency at which objects (vehicles or the like) traveling facing the vehicle M are passed, or an average movement speed of objects. When the detection frequency is high, the passage frequency is high, or the average movement speed is fast, stress is predicted to increase. Therefore, the correction value may be set to a larger value. In this case, in the stress suppression information 152, a classified pattern is associated with each detection frequency, each passage frequency, or each average movement speed. The predictor 124 acquires the detection frequency, the passage frequency, or the average movement speed according to an image recognition result. Then, with reference to the stress suppression information 152, the corrector 125 specifies a classified pattern according to the detection frequency, the passage frequency, or the average movement speed and acquires the correction value.

Hereinafter, a process of generating the stress suppression information 152 by the analysis device 400 will be described.

### [Analysis Device]

FIG. 12 is a diagram showing a functional configuration of the analysis device 400. The analysis device 400 includes, for example, a communicator 402, an analyzer 404, a deliverer 406, and a storage 420. The communicator 402 is a communication interface that communicates with a vehicle. The vehicle is an automated driving vehicle and is a vehicle that travels along a trajectory generated by the action plan generator 123. The analyzer 404 analyzes information acquired from the vehicle (the details of which will be described below). The deliverer 406 delivers a result of analysis of the analyzer 404 to the vehicle.

The storage 420 stores map information 422, vehicle information 424, collection information 426, correspondence information 428, stress suppression information 430, and section information 432. The map information 422 is map information with similar high precision to the second map information 62. The vehicle information 424 is information including a vehicle ID, a kind of vehicle, a communication address of the vehicle, and information regarding an imaged region imaged by a camera mounted in the vehicle.

The collection information 426 is a traveling route or trajectory of a vehicle acquired from the vehicle, an image captured by a camera mounted in the vehicle, information detected by a biological sensor worn on the body such as a wrist of an occupant of the vehicle, and the like. A time at which the information is acquired is associated with the information included in the collection information 426.

The biological sensor acquires a fluctuation in heartbeats of an occupant (a periodic interval of heartbeats) and derives stress according to the acquired fluctuation in heartbeats. The biological sensor includes a heartbeat sensor, a determiner, a communicator, and a storage. The determiner of the biological sensor sorts, for example, signals indicating the detected heartbeats into high-frequency and low-frequency components and determines that stress is higher as the low-frequency component is larger than the high-frequency component. Then, the determiner stores a determination result in the storage and transmits the determination result to the vehicle at each predetermined time using the communicator.

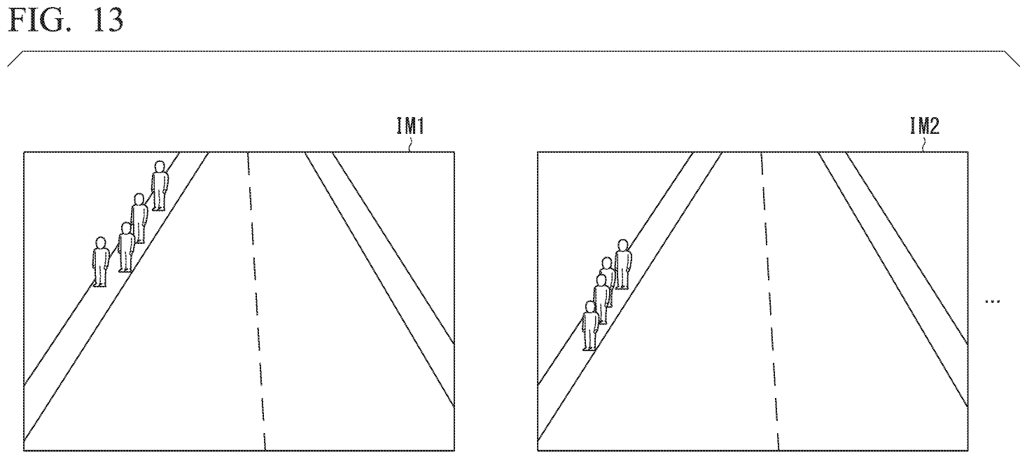

FIG. 13 is a diagram showing an example of an image captured by a camera of a vehicle. For example, images (IM1, IM2, and the like in the drawing) captured by the camera at predetermined time intervals are associated with times to be transmitted to the analysis device 400.

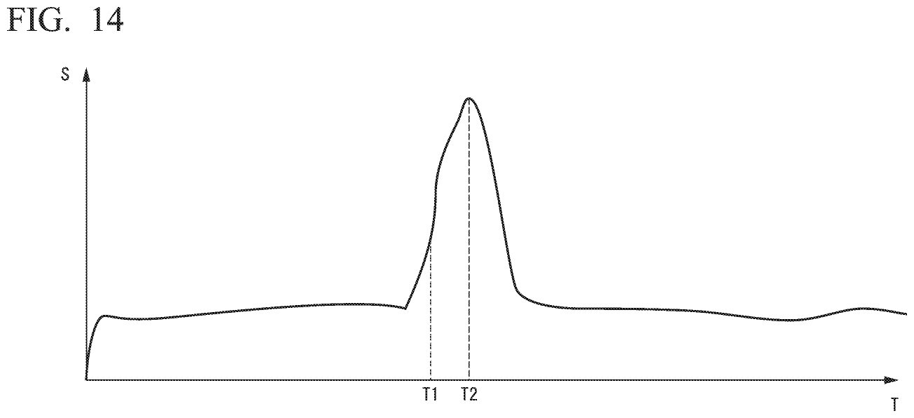

FIG. 14 is a diagram showing an example of information regarding stress transmitted from a biological sensor to a vehicle. In the drawing, the vertical axis represents the extent of stress and the horizontal axis represents a time. A change in the extent of stress is recognized in accordance with the information acquired by the biological sensor. In the shown example, at time T1 at which the image IM1 in FIG. 14 is captured, stress becomes higher than during the normal time. At time T2 at which the image IM2 in FIG. 14 is captured, stress is further increases. In this way, a cause and effect relation between surrounding information of the vehicle and stress is recognized in accordance with the collection information 426.

### [Process of Analysis Device]

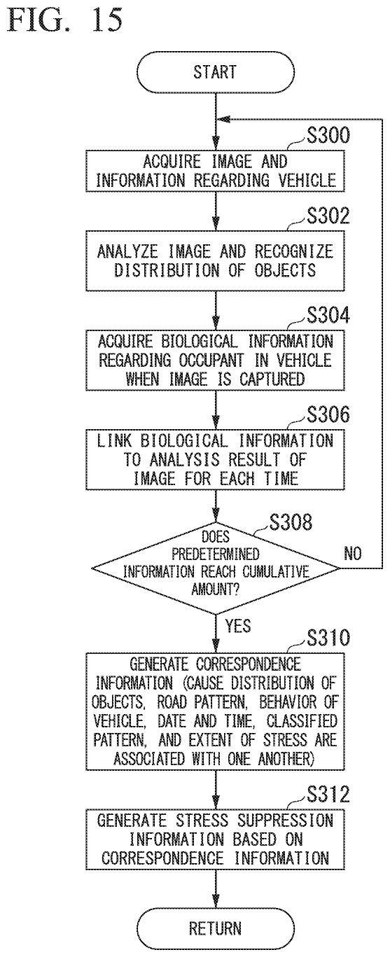

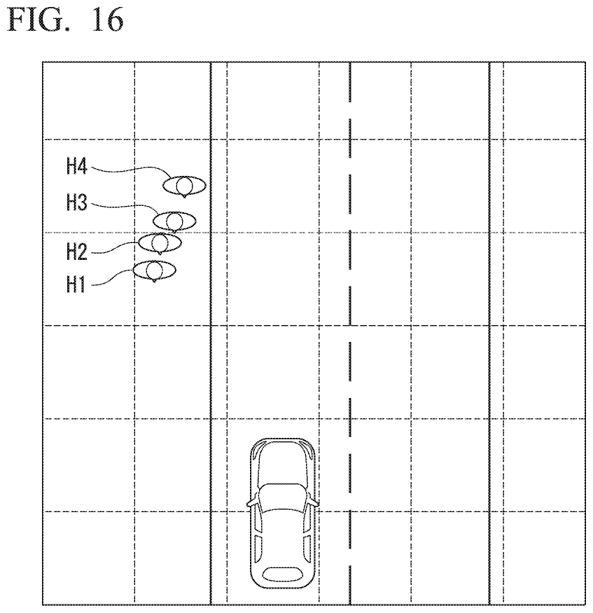

FIG. 15 is a flowchart showing a flow of a process performed by the analysis device 400. First, the analyzer 404 acquires an image captured by a camera of the vehicle and information regarding a vehicle (a behavior of the vehicle, a trajectory, or positional information) at the time of capturing of the image (step S300). Subsequently, the analyzer 404 analyzes the acquired image and recognizes a distribution of objects (step S302). For example, as shown in FIG. 16, the analyzer 404 converts the image IM1 in FIG. 13 described above into a bird's eye view image and recognizes a distribution of the objects (humans H1 to H4) in a mesh region obtained by dividing a region associated with the bird's eye view image with a size serving as a reference. FIG. 16 is a diagram showing an example of a bird's eye view image.

Subsequently, the analyzer 404 acquires biological information regarding an occupant in the vehicle when the image acquired in step S300 is captured (step S304). Subsequently, the biological information acquired in step S304 is linked to an analysis result of the image for each time (step S306). Subsequently, the analyzer 404 determines whether the information linked in step 306 reaches by a predetermined cumulative amount or more (step S308). When the information is not accumulated by the predetermined amount or more, the process returns to step S300. The accumulation of the information by the predetermined amount or more is a cumulative predetermined number or more of combinations of the biological information and the analysis results of the image linked at each time.

When the information is accumulated by the predetermined amount or more, the analyzer 404 generates correspondence information 428 by associating the distribution of the objects, the road pattern, the behavior of the vehicle, an imaging date and time of the image, the classified pattern, and the extent of stress acquired in step S302 with one another (step S310).

Subsequently, the analyzer 404 generates the stress suppression information 430 according to the correspondence information 428 (step S312). For example, the analyzer 404 requests a behavior of the vehicle in which stress on the occupant is suppressed for each classified pattern according to data requested experimentally in advance. Then, the analyzer 404 derives a correction value of the behavior of the vehicle for each classified pattern and generates the stress suppression information 430 in which the correction value is associated with the classified pattern and the extent of stress. Thus, the process of one routine of the flowchart ends.

In the stress suppression information 430, correction values larger than those of other classified patterns may be associated with a classified pattern indicating that a road is crowded, a classified pattern indicating that the number of objects is large, a classified pattern indicating that there is an object parked or stopped on a road, a classified pattern indicating that there is the vehicle M turning right or turning left, and a classified pattern indicating that the extent of stress on an occupant increases due to a narrow width of a road or the like. For a classified pattern including a road pattern in which the number of traveling lanes is large, a correction value larger than a classified pattern which is a road pattern in which the number of traveling lanes is small is set since stress on an occupant is predicted to increase.

The classified pattern may be determined for each kind of object. Kinds of objects are children, adults, bicycles, two-wheeled vehicles, four-wheeled vehicles, and the like. For example, when children are distributed in a predetermined region, a larger correction value is associated than when adults are distributed in the predetermined region. This is because an occupant experiences more stress when there is a child than when there is an adult.

The analyzer 404 generates the section information 432 in which a traveling section, a period of time in which a vehicle travels through the section, and the extent of stress when the vehicle travels through a predetermined section according to the trajectory generated by the action plan generator 123 are associated with one another.

The stress suppression information 430 and the section information 432 are delivered to the vehicle M by the deliverer 406.

In the above-described example, the classified pattern has been specified and the correction value has been determined, but instead of (in addition to) this, the correction value may be determined according to a monitoring result of the occupant monitor 130. For example, when the extent of stress on an occupant acquired by the occupant monitor 130 increases to be equal to or greater than a standard value, the corrector 125 may correct the trajectory so that the vehicle decelerates its speed or travels through a position away from nearby objects. The position at which the vehicle travels further away is a position further away than a position at which the vehicle travels along the trajectory generated by the action plan generator 123. For example, the storage 150 stores an association table in which a correction value is associated with each stress. The corrector 125 acquires the correction value in accordance with the extent of stress with reference to the association table.

According to the above-described embodiment, stress caused to an occupant can be suppressed by including the external recognizer 121 that detects objects around the vehicle M, the predictor 124 that predicts the stress caused to an occupant by the objects according to a distribution of the objects detected by the external recognizer 121; and the first controller 120 that generates a trajectory when the vehicle M is traveling by automated driving according to the stress predicted by the predictor 124.

While preferred embodiments of the invention have been described and shown above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### REFERENCE SIGNS LIST

1 Vehicle control system
2, 2A Vehicle control system
100 Automated driving controller
121 External recognizer
123 Action plan generator
124 Predictor
125 Corrector
150 Storage
152 Stress suppression information
154 Section information
156 Pattern information
400 Analysis device
404 Analyzer
406 Deliverer
M1. M2 Vehicle

1. A vehicle control system comprising:
a detector configured to detect objects around a vehicle;
a predictor configured to predict the extent of stress caused to an occupant by the objects according to a distribution of the objects detected by the detector;
a controller configured to generate a trajectory when the vehicle is traveling by automated driving according to the extent of stress predicted by the predictor; and
an occupant monitor configured to estimate the extent of stress on the occupant,
wherein, when the vehicle is traveling along the generated trajectory a predetermined time before and the extent of stress estimated by the occupant monitor is equal to or greater than a second threshold, the controller is configured to correct a trajectory for the vehicle to travel by the automated driving according to the extent of stress estimated by the occupant monitor.

2. The vehicle control system according to claim 1, wherein the controller is configured to generate a trajectory when the vehicle is traveling automatically according to the extent of stress predicted by the predictor and the distribution of the objects detected by the detector.

3. The vehicle control system according to claim 2, wherein the trajectory is a trajectory in which the extent of stress on the occupant is equal to or less than a first threshold.

4. The vehicle control system according to claim 3, wherein the trajectory in which the extent of stress on the occupant is equal to or less than the first threshold is a trajectory passing through a position further away from the objects than a trajectory in which the extent of stress on the occupant is greater than the first threshold.

5. The vehicle control system according to claim 4, wherein the trajectory in which the extent of stress on the occupant is equal to or less than the first threshold is a trajectory in which a vehicle speed or acceleration is suppressed further than the trajectory in which the extent of stress on the occupant is greater than the first threshold.

6. (canceled)

7. The vehicle control system according to claim 1, wherein, with reference to information regarding a specific route in which it is predicted that the extent of stress when the vehicle is traveling is equal to or greater than a third threshold, the controller is configured to determine that the vehicle is traveling preferentially along a route different the specific route.

8. A vehicle control method comprising:
detecting objects around a vehicle;
predicting the extent of stress caused to an occupant by the objects according to a distribution of the detected objects; and
generating a trajectory when the vehicle is traveling by automated driving according to the predicted extent of stress; and
estimating the extent of stress on the occupant,
when the vehicle is traveling along the generated trajectory a predetermined time before and the extent of stress estimated by the occupant monitor is equal to or greater than a second threshold, correcting a trajectory for the vehicle to travel by the automated driving according to the extent of stress estimated by the occupant monitor.

9. A non-transitory computer-readable storage medium that stores a computer program to be executed by a computer to perform at least:
detect objects around a vehicle;
predict the extent of stress caused to an occupant by the objects according to a distribution of the detected objects; and
generate a trajectory when the vehicle is traveling by automated driving according to the predicted extent of stress; and
estimate the extent of stress on the occupant,
when the vehicle is traveling along the generated trajectory a predetermined time before and the extent of stress estimated by the occupant monitor is equal to or greater than a second threshold, correct a trajectory for the vehicle to travel by the automated driving according to the extent of stress estimated by the occupant monitor.
